(19) United States
(12) Patent Application Publication
(10) Pub. No.: US 2002/0107706 A1
(43) Pub. Date: Aug. 8, 2002

(54) Virtual negotiation

(76) Inventors: Mitchell B. Oliver, San Diego, CA (US); Mazen Chmaytelli, San Diego, CA (US); Jerry Horel, Brentwood Bay (CA); Vicki Mealer, Escondido, CA (US); Matthew Small, San Diego, CA (US)

Correspondence Address: QUALCOMM Incorporated, Attn: Patent Department, 5775 Morehouse Drive, San Diego, CA, 92121-1714, US

(21) Appl. No.: 10/062,117

(22) Filed: Jan. 30, 2002

Related U.S. Application Data
(60) Provisional application No. 60/266,022, filed on Feb. 2, 2001.
(60) Provisional application No. 60/312,737, filed on Aug. 15, 2001.

(51) Int. Cl. G06F 17/60

(52) U.S. Cl. 705/2

(57) ABSTRACT

The present invention provides systems and methods for the distribution and billing associated with downloading data to a wireless device. In one embodiment, a distribution center having a Unified Application Management (UAM) system performs much of the processing intensive tasks associated with downloading applications to a wireless device. A server located at the carrier facility, e.g., an Application Download Server (ADS), performs that minimal processing necessary to download relevant application information and record transaction data. In this embodiment, the ADS does not contain a relational database and communicates transaction data and information associated with applications using Extensible Markup Language (XML). The structure of the XML files used for this communication may further be optimized to only require one-pass processing thus minimizing the processing requirements of the ADS. A transaction server processes transaction data for billing.

### CROSS REFERENCE TO RELATED APPLICATIONS

This application claims the benefit of U.S. Provisional Application Serial No. 60/266,022, filed on Feb. 2, 2001, and to U.S. Provisional Application Serial No. 60/312,737, filed on Aug. 15, 2001, which applications are incorporated herein by reference in their entirety.

### BACKGROUND

I. Field of the Invention

The present invention relates wireless networks and communications across wireless networks. More particularly, the present invention relates to the distribution and billing of software for a wireless device.

II. Description of the Related Art

Wireless communication has experienced explosive growth in recent years. As consumers and businesses rely more on their wireless devices, such as mobile phones and personal digital assistants (PDAs), wireless service providers, i.e., carriers, strive to provide additional functionality on these wireless devices. This additional functionality would not only increase the demand for wireless devices but also increase the usage among current users. Increasing functionality, specifically by increasing the applications accessible by the wireless device, however, is costly and complicated thereby discouraging carriers from providing this functionality.

Furthermore, developers of applications for wireless devices encounter several obstacles. Developers want to create applications that will be supported by as many wireless devices as possible. This increases their market share for that application. One of the obstacles encountered by developers, though, includes having to develop applications that will be supported and administered by multiple carriers having multiple wireless device platforms. Each carrier could have distinct processes for managing the applications thereby creating additional overhead for the application developer to support each of these processes.

Typically, to support the downloading of applications to a wireless device, the carrier would employ a computer system to manage the applications and download process. This system must be robust and capable of handling a significant processing load. For example, the system must be capable of managing all the applications supported by the carrier, identifying the applications that support specific wireless device platforms supported by the carrier, updating applications as new versions are developed, recording the transaction of downloading an application to a wireless device, and processing the billing associated with the transaction. This processing needs to be performed for each requested download, for each wireless device making the request for all the devices supported by the carrier.

For each of the carriers to develop and implement a system capable of this amount of processing, however, is expensive. This implementation expense compounded with the application developers added expense and overhead to support multiple carriers inhibited the distribution and development of applications over wireless networks.

What is needed in the art is a method and system that addresses these problems by encouraging application development and carriers' large-scale implementation of application downloads to wireless devices.

### SUMMARY OF THE INVENTION

The present invention satisfies the need in the art by providing a systems and methods for encouraging large scale downloading to wireless devices. In one aspect of the present invention, a method for negotiating information associated with a first product between multiple entities comprises receiving a first data associated with the first product from a first delivery entity, presenting to the multiple receiver entities, the data associated with the first product, receiving a first modification to the first data by the first receiver entity, presenting the first modification to the first data to the first delivery entity, receiving an acceptance of the first modification from the first delivery entity, and associating the first modification with the first receiver entity.

In another aspect of the present invention, a method of negotiating metadata associated with an application for execution on a wireless device comprises receiving metadata associated with multiple applications, presenting the metadata to multiple carriers, providing an automated negotiation forum for the carriers and developers, receiving into the negotiation forum, modifications to the metadata from carriers, modifications to the metadata from developers, acceptance requests from carriers and acceptance requests from developers, and associating metadata associated with one of the multiple applications with a carrier.

In yet another aspect of the present invention, a method for providing a negotiation forum, comprises providing electronic access to an automated system to multiple delivery entities and multiple receiver entities, presenting to the multiple receiver entities metadata associated with products associated with the multiple delivery entities, receiving modification terms associated with the metadata associated with the products associated with the multiple delivery entities, receiving acceptance of modifications to the metadata, and associating the modification of the metadata with multiple receiver entities.

Other objects, advantages, and features of the present invention will become apparent after review of the hereinafter set forth Brief Description of the Drawings, Detailed Description of the Invention, and the Claims.

### BRIEF DESCRIPTION OF THE DRAWINGS

The accompanying drawings, which are incorporated in and constitute a part of the specification, illustrate presently preferred embodiments of the invention and, together with the general description given above and the detailed Description of the Preferred Embodiments given below, serve to explain the principles of the invention. In the drawings:

FIG. 1 depicts an exemplary embodiment of a system architecture of the present invention;

FIG. 2 depicts catalog management services to be provided to carriers and certification centers for configuring catalogs on an application distribution system (ADS) in an exemplary embodiment of the present invention;

FIG. 3 depicts the Unified Application Management (UAM) services in an exemplary embodiment of the present invention;

FIG. 4 depicts a transaction (TX) and billing data flow diagram in an exemplary embodiment of the present invention;

FIG. 5 depicts the application distribution and billing system interacting with other systems in an exemplary embodiment of the present invention;

FIG. 6 depicts the process of virtual negotiation between multiple carriers and multiple developers in an exemplary embodiment of the present invention; and

FIG. 7 depicts the end-to-end automated process of purchase, distribution, and billing for an application for a wireless device in an exemplary embodiment of the present invention.

### DESCRIPTION OF AN EXEMPLARY EMBODIMENT

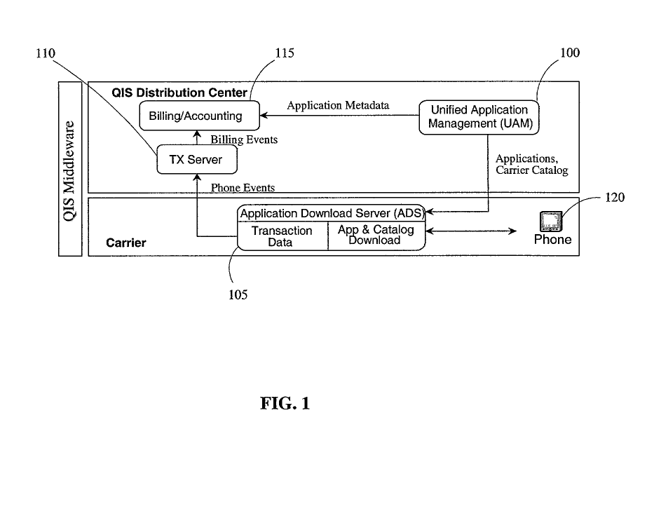

FIG. 1 depicts one exemplary embodiment of the system architecture of the present invention. The components include a Unified Application Management (UAM) system 100, an Application Download Server (ADS) 105, a Transaction (TX) Server and a Billing/Accounting system 115.

Unified Application Management (UAM) 100

The Unified Application Management (UAM) system 100 is a core service implemented, in one embodiment, as a part of the QIS Middleware. (QIS Middleware is part of the BREW™ architecture developed by QUALCOMM Inc., headquartered in San Diego, Calif., which is a larger umbrella suite of programs that includes other functions, such as authentication of certified applications.) The UAM 100 is a centralized suite of application management services targeted to reside in the QIS Distribution Center (QDC). The UAM provides the following key services relating to wireless application management, carrier distribution and billing, including:

The UAM is a central repository which manages application files and application metadata;

The UAM manages the distribution of wireless applications to carrier site download servers;

The UAM provides services to configure the distribution of applications to carrier sites via carrier catalog management services; and

The UAM manages application metadata used for accounting/billing services this data is transmitted to the billing/accounting system 115. This metadata may be transmitted directly to the billing/accounting system 115 or via the TX server 110.

Application Download Server (ADS) 105 and Transaction (TX) Server 110

The Application Download Server (ADS) 105 is another core service implemented, in one embodiment, as part of the QIS Middleware. The ADS 105 interfaces to the UAM 100 for managing carrier catalog and applications to be distributed from a particular carrier site. The UAM 100 may interface to multiple carriers and a carrier may host multiple ADS'. Each ADS 105 may be configured for distribution of similar or unique applications by using the UAM catalog management services (described below). The ADS interfaces with a wireless device, such as a cellular phone 120, to display the catalog of applications available for download and enables the user to select application(s) to download. For specific wireless device user transactions, the ADS may log the events locally on the ADS. The ADS may replicate the transaction data to the Transaction (TX) server 110 at the QDC for consolidation. This consolidated transaction data will be used to derive billing and accounting transactions. While a phone 120 is depicted in FIG. 1, other wireless devices may be used.

UAM to ADS Interface

The catalog and application data moves from the UAM to the ADS. In one embodiment, the interface between the UAM and the ADS is designed as an XML file interface. There is no database resident or required on the ADS server. Application and catalog management services between the UAM and the ADS was intentionally designed for lightweight servers that did not require a RDBMS (relational database). The ADS management logic is optimized for performing efficiency (i.e., one-pass parse of data streams). Inherent in the design is the capability to deploy low cost carrier download servers across worldwide carrier sites.

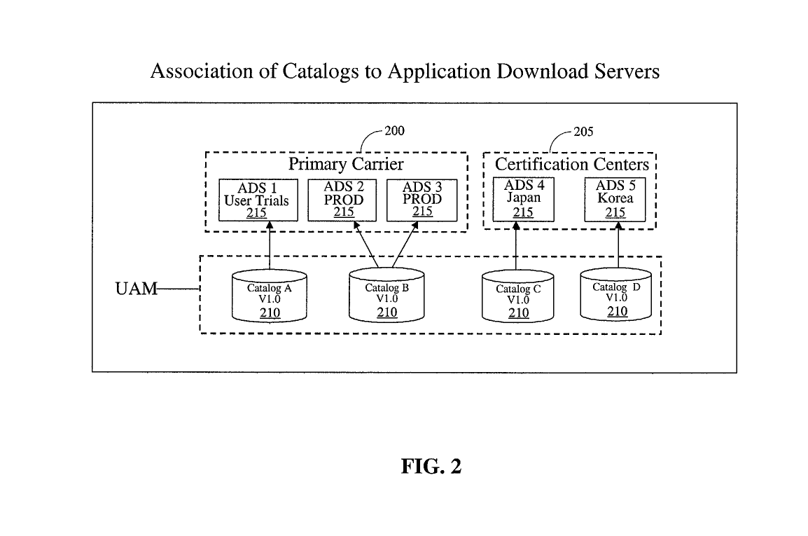

FIG. 2 depicts the catalog management services to be provided to carriers 200 and certification headquarters (ACCHQ) 205 for configuring catalogs 210 on the ADS' 215 in an exemplary embodiment of the present invention. The catalog is the method for distributing applications to a particular ADS. An ADS may be configured to support various functional modes, such as, carrier user trials, production, or application certification testing.

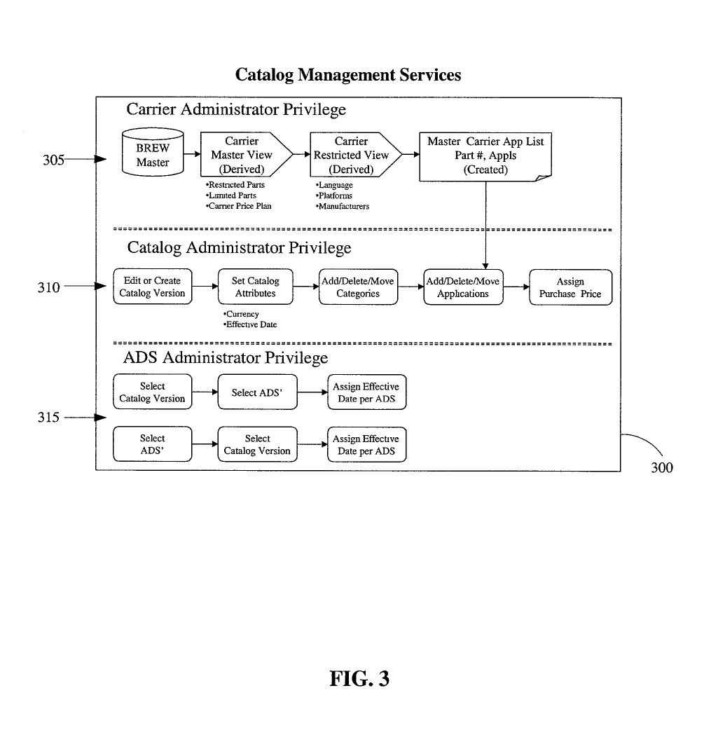

FIG. 3 depicts the UAM catalog management services in an exemplary embodiment.

The UAM catalog management services 300 are designed to manage the distribution of catalogs across autonomous services (i.e., user trials, production and certification testing). FIG. 3 identifies the types of catalog management functions to be provided by UAM. The carrier administrator 305 manages the master carrier application list and the carrier global application restrictions. The master carrier application list is the “pick list” of applications to include or exclude from carrier catalogs. The catalog administrator 310 manages catalog versions and inclusion and deletion of applications from a catalog; the applications having been selected from the master carrier application list. The catalog administrator will also set application purchase price in the catalog where authorized by the carrier administrator. The ADS Administrator 315 assigns catalog versions to the ADS' and assigns effective dates. The administrator functions may be performed on the UAM via a separate interface, such as through an extranet connection to the UAM from the carrier (not shown). It will be recognized by those skilled in the art that a privilege may be established giving access to perform multiple or all functions depicted in FIG. 3.

The present invention may also include automated Catalog Activation. In this embodiment, the UAM uses effective date and catalog data provided by carrier. The UAM also exposes an API to the ADS' for efficient delivery of: XML summary catalog, XML category list, XML extended catalog with pricing and other information, XML revoked application list, XML auto-install list and application packages. The UAM notifies the ADS of a new catalog. The ADS pulls the catalog and validates/updates the file directory. In addition, the ADS makes new catalog available to subscribers.

The present invention may also include a MIN/Application mapping matrix. It may maintain a current mapping of applications by MIN based on download and delete events recorded by the ADS, accounting for Pre-Installed Applications (Provisioning Data Report), and accounting reassigned MINs, i.e., MIN transfers, (Provisioning Data Report). Mapping information may be used to derive invoice to carrier for enablement and other associated fees, to derive subscription billing events, and to generate a MIN list for application recall.

Transaction and Billing Data Flow

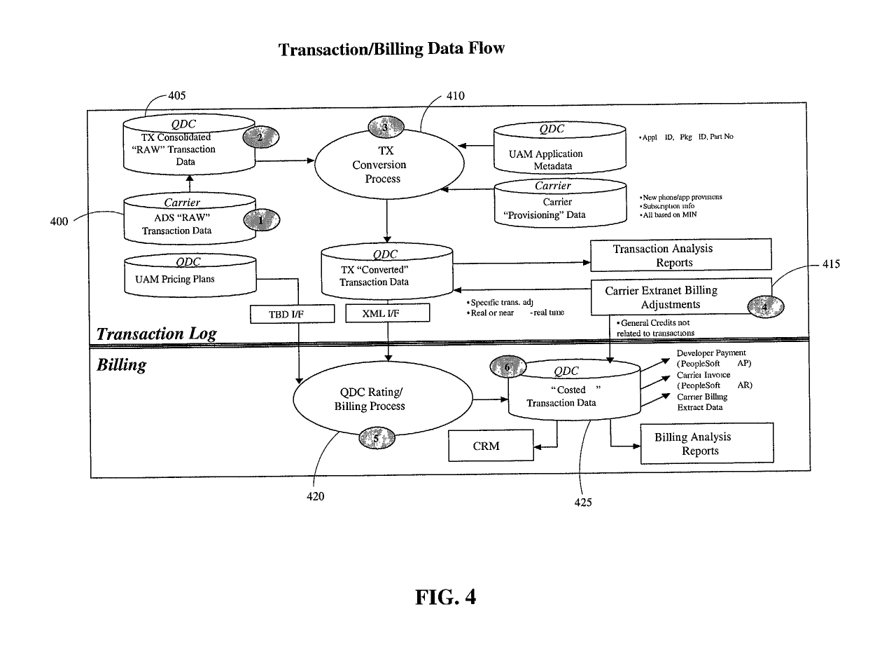

FIG. 4 depicts a transaction (TX) and billing data flow diagram in an exemplary embodiment of the present invention. Transaction data is collected on each ADS and is identified as ADS “raw” transaction data (Step 400). The QDC transaction server will collect the raw” transaction data across multiple ADS' and stage the data into the consolidated raw transaction data via XML interfaces (or other interface defined to the system) (Step 405).

Once the ADS “raw” transaction data is staged in the QDC transaction server, a TX conversion process is executed that generates the TX “converted” transaction data. The conversion process has multiple data inputs: TX consolidated “raw” transaction data, UAM application metadata (includes Application ID to Part Number mappings), and carrier provisioning data. The conversion process consolidates and converts all of the transactions from the input sources and generates the TX “converted” transaction data (Step 410).

Carriers may apply billing adjustments associated with ADS transactions to the “converted” transaction or adjustments to the “costed” transaction data, via the carrier extranet, in one embodiment (Step 415).

The TX “converted” transaction data is used as the “data of record” for processing billing related transactions (Step 420). The QDC Rating/Billing Process uses the TX “converted” transaction data and the UAM billing logic, such as pricing plans, to generate the “costed” transaction data. This “costed” transaction data is used to generate developer payment, the invoices are sent to carriers for enablement services, and the carrier billing data extract file(s) that can be used for subscriber billing (Step 425). It will be recognized by one skilled in the art that the carrier billing extract data function may be performed other components, including the transaction server. The derived accounts receivable (AR) and accounts payable (AP) may then be processed using a business application, for example, PeopleSoft business software, which is known in the art.

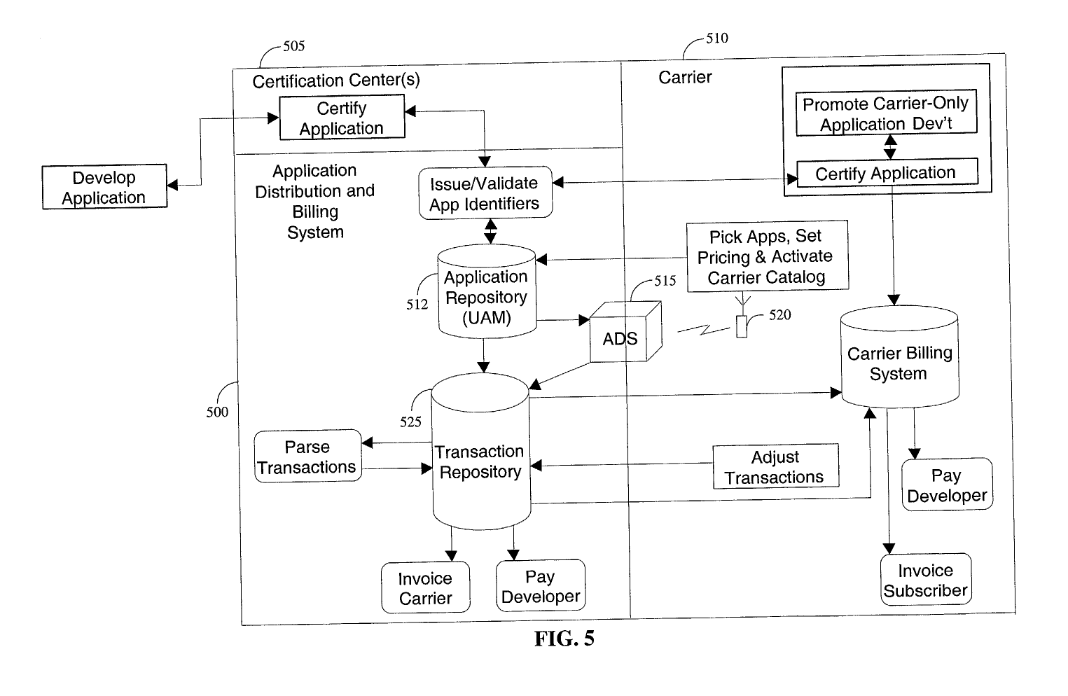

FIG. 5 depicts the application distribution and billing system interacting with other systems in an exemplary embodiment of the present invention. In one embodiment, the application distribution and billing system 500 may receive certified applications from a certification center 505 or receive carrier-managed applications directly from the carrier. Applications reside in a central application repository (UAM) 512. They may be processed by issuing and/or validating application identifiers prior to storage in the UAM 512.

In one embodiment, applications are defined to a category and submitted to an ADS 515. The ADS 515 may be managed or controlled by the carrier 510, the application distribution and billing system 500, or a combination of both. A catalog and application may be downloaded to a wireless device 520 where the application may execute. The carrier 510 may interface with the UAM 512 to configure the catalog, including selecting the applications, available to be downloaded to the wireless device 520 supported by the carrier's network (not shown). The carrier may work with the developer to adjust various information, or metadata, associated with the application including pricing, which catalog to assign the application, which wireless devices may access the application, time to expire, or number of uses. It will be recognized by those skilled in the art that there are numerous events, or metadata, associated with the purchase, billing and downloading of a product or application.

The ADS 515 will log transactions associated with the downloads to the wireless device 515 and send this information to a Transaction Repository 525 (which is part of a transaction server in one embodiment). In processing the billing for the download, the carrier 510 may adjust metadata associated with the download transaction in the transaction repository. Transactions are consolidated and invoices are generated for the carrier and payment sent to the developer.

In one embodiment, an automated transaction collection is implemented. The process of automated transaction collection includes, upon successful download of an application, the ADS capturing the MIN, Application Name, Application ID, Purchased Plan, Purchase Price, Time/Date. The ADS transmits, including by replication, data to transaction server at specific intervals (e.g., every 30 minutes) or more frequently, e.g., in near real time, as required, e.g., based on file sized exceeding a threshold. The transaction server binds transaction to business data. This binding process may be used to resolve part number, carrier information, billing parameters, parse transactions into a relational database, splits out restricted application transactions, and delivers restricted application raw data to carrier.

The billing and collections process may include the following events:

Compiling Phone Purchased Application Transactions Compiled on ADS and Forwarding

Carrier Providing a List of Applications Preinstalled

Carrier Providing a List of MIN Deactivations/Reassignments

Sending Restricted Application Transactions Automatically to Carrier

Carrier Adjusting Standard Transactions via Carrier Extranet

Standard (STD) Transactions Rated (i.e., Priced)

Carrier Adjusting Rated STD Transactions via Carrier Extranet

Adjusting Rated STD Transactions for Subscriber Billing Delivered to Carrier

Using Matrix of MIN vs. Apps to Determine 1^{st} Time Downloads

Application Distribution and Billing System Invoicing for Downloads

Application Distribution and Billing System Invoicing Carrier for Developer Payment on Standard Apps

Application Distribution and Billing System Paying Developers for Standard Application

Carrier Paying Developers for Restricted Applications

Delivering All Converted Transactions and Adjustments to Carrier

Deriving subscription bill events for monthly billing

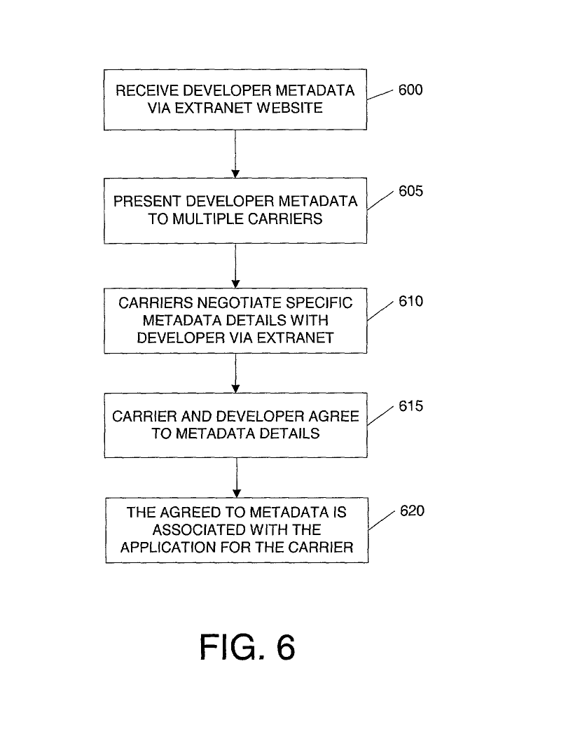

FIG. 6 depicts the process of virtual negotiation between multiple carriers and multiple developers in an exemplary embodiment of the present invention. The distribution and application system receives metadata related to a product, such as an application, via a website (Step 600). It will be recognized that while this description includes the use of carriers and developers, that these are representative of any entities that may interact for the distribution and/or billing of a product.

The metadata is then presented to multiple carriers (Step 605). Note that this presentation may be performed by using the extranet and having the carrier log into the extranet to view the metadata associated with an application. Further, in one embodiment, multiple developers submit applications, each having an associated metadata, and the multiple carriers can view the metadata submitted from the multiple developers.

Carriers then negotiation specific metadata details with the developer via the extranet (Step 610). For example, the developer may submit a price associated with an application to charge a user/subscriber of the application. The carrier, upon viewing the price, may reject it and submit, by sending a message or entering data into a field on the extranet, a price the carrier would like to associate with the application. The developer may agree or respond with a counteroffer. This negotiation may occur several times, all over the extranet. Furthermore the negotiation may occur between multiple carriers and multiple developers all through the extranet. This includes concurrent negotiations between multiple carrier-developer pairs. This provides the benefit that a developer or a carrier can go to one place to view available products or purchases and not have to establish unique negotiating methods or paradigms with all the entities involved. In other words, the same interface and method may be used to negotiate different metadata between multiple entities.

The carrier and developer may eventually agree to the metadata details (Step 615). This agreed to metadata and its association with the carrier, developer and the application, is stored in a central repository, such as in the UAM, for other processes, such as to determine billing and historical analysis (Step 620).

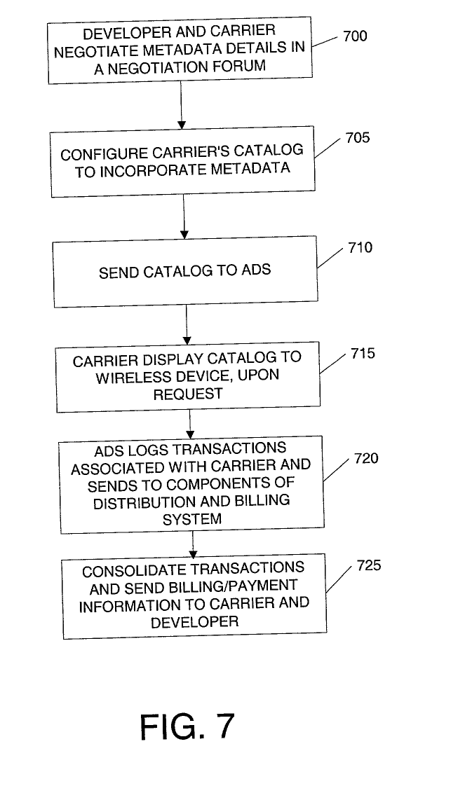

FIG. 7 depicts the end-to-end automated process of purchase, distribution, and billing for an application for a wireless device in an exemplary embodiment of the present invention. The developer and carrier initially agree to negotiated metadata associated with an application using a negotiation forum, such as the extranet described with respect to FIG. 6 above (Step 700). The catalog associated with the carrier is then configured to include this metadata (Step 705). In one embodiment, the carrier interacts with the UAM to define specific catalogs, for example, defining which applications are defined to the catalog, which wireless devices may access them, and/or which ADS's will have access to the catalog.

The catalog is then sent to the ADS as defined by the carrier (Step 710). When a wireless device requests access to applications, the ADS will transmit data, using the carrier's network, to the wireless device showing the catalog(s) and any metadata it determines may be useful, e.g., price structure, license agreements, etc. (Step 715). It may take multiple transmissions based on selections received from the wireless device to transmit all the desired catalog and metadata to the wireless device.

When the wireless device requests data, downloads an application or performs other actions with the ADS, this information may be recorded as a transaction. The carrier, via the ADS, logs the transaction and sends this transaction information to systems within the distribution and billing system (Step 720). The transaction data is consolidated and invoices and payments are processed and distributed to the entities as agreed to between the entities (Step 725). Such agreement includes the metadata that was agreed to using the negotiation forum.

Conclusion

The present invention simplifies the environment for developing applications and providing these applications to a wireless device by providing a centralized system to offload the processing used to manage the applications downloaded to the wireless device. By providing the centralized system, such as a Unified Application Management (UAM) system in a QIS Distribution Center with a local Application Download Server (ADS), the carriers have a low cost implementation mechanism to distribute applications over their wireless networks. In addition, application development is simplified because of the centralized administration of the applications across multiple carriers and wireless device platforms.

In one embodiment, the present invention provides a distribution center having a Unified Application Management (UAM) system to perform much of the processing intensive tasks, such as data management, associated with downloading applications to a wireless device. A server located at the carrier facility, e.g., an Application Download Server (ADS), performs that minimal processing necessary to download relevant application information and record transaction data. In this embodiment, the ADS does not contain a relational database and communicates transaction data and information associated with applications using Extensible Markup Language (XML). The structure of the XML files used for this communication may further be optimized to only require one-pass processing thus minimizing the processing requirements of the ADS. Because the ADS does not require a relational database, it provides a low cost solution for carrier specific components.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but one embodiment of the present invention may be implemented as a combination of hardware and software or in hardware alone. The invention may be implemented with both object-oriented and non-object-oriented programming systems.

Additionally, although aspects of the present invention are described as being stored in memory, those skilled in the art will appreciate that these aspects can also be stored on other types of computer-readable media, such as secondary storage devices, like hard disks, floppy disks, or CD-ROM; a carrier wave from the Internet or other propagation medium; or other forms of RAM or ROM. The scope of the invention is defined by the claims and their equivalents.

What is claimed is:

1. A method for negotiating information associated with a first product between multiple entities, comprising:
receiving a first data associated with the first product from a first delivery entity;
presenting to the multiple receiver entities, the data associated with the first product;
receiving a first modification to the first data by the first receiver entity;
presenting the first modification to the first data to the first delivery entity;
receiving an acceptance of the first modification from the first delivery entity; and
associating the first modification with the first receiver entity.

2. The method of claim 1 further comprising storing the product and the first modification in a central repository.

3. The method of claim 1 further comprising:
receiving a second modification to the first data from a second receiver entity;
receiving an acceptance of the second modification from the first delivery entity; and
associating the second modification with the second receiver entity in addition to associating the first modification with the first receiver entity.

4. The method of claim 3 further comprising:
receiving a second data associated with a second product from a second delivery entity;
presenting to the multiple receiver entities, the second data associated with the second product;
receiving a first modification to the second data from a one of the multiple entities;
receiving an acceptance of the first modification to the second data from the second delivery entity; and
associating the first modification to the second data with the one of the multiple entities.

5. A system for negotiating information associated with a first product between multiple entities, comprising:
means for receiving a first data associated with the first product from a first delivery entity;
means for presenting to the multiple receiver entities, the data associated with the first product;
means for receiving a first modification to the first data by the first receiver entity;
means for presenting the first modification to the first data to the first delivery entity;
means for receiving an acceptance of the first modification from the first delivery entity; and
means for associating the first modification with the first receiver entity.

6. The system of claim 1 further comprising:
means for receiving a second modification to the first data from a second receiver entity;
means for receiving an acceptance of the second modification from the first delivery entity; and
means for associating the second modification with the second receiver entity in addition to associating the first modification with the first receiver entity.

7. The system of claim 6 further comprising:
means for receiving a second data associated with a second product from a second delivery entity;
means for presenting to the multiple receiver entities, the second data associated with the second product;
means for receiving a first modification to the second data from a one of the multiple entities;
means for receiving an acceptance of the first modification to the second data from the second delivery entity; and
means for associating the first modification to the second data with the one of the multiple entities.

8. A method for negotiating data associated with multiple products between multiple developers and multiple carriers, comprising:
receiving data associated with multiple products into a central repository;
presenting the data to multiple carriers;
receiving from a first carrier, a first modification to a first data portion associated with a first product;
presenting to a first developer associated with the first product, the first modification;
receiving an acceptance of the first modification; and
associating the first modification with the first product and the first carrier.

9. The method of claim 8 further comprising:
receiving from a second carrier, a second modification to the first data associated with the first product;
presenting the second modification to the first developer associated with the first product;
receiving an acceptance of the second modification; and
associating the second modification with the first product and the second carrier in addition to associating the first modification with the first product and the first carrier.

10. The method of claim 8, wherein the multiple products are associated with different developers.

11. A system for negotiating data associated with multiple products between multiple developers and multiple carriers, comprising:
means for receiving data associated with multiple products into a central repository;
means for presenting the data to multiple carriers;
means for receiving from a first carrier, a first modification to a first data portion associated with a first product;
means for presenting to a first developer associated with the first product, the first modification;
means for receiving an acceptance of the first modification; and
means for associating the first modification with the first product and the first carrier.

12. The system of claim 11 further comprising:
means for receiving from a second carrier, a second modification to the first data associated with the first product;
means for presenting the second modification to the first developer associated with the first product;
means for receiving an acceptance of the second modification; and
means for associating the second modification with the first product and the second carrier in addition to associating the first modification with the first product and the first carrier.

13. The system of claim 11, wherein the multiple products are associated with different developers.

14. A computer-readable medium having computer executable instructions that when execute perform a method for negotiating data associated with multiple products between multiple developers and multiple carriers, comprising:
receiving data associated with multiple products into a central repository;
presenting the data to multiple carriers;
receiving from a first carrier, a first modification to a first data portion associated with a first product;
presenting to a first developer associated with the first product, the first modification;
receiving an acceptance of the first modification; and
associating the first modification with the first product and the first carrier.

15. The computer readable means of claim 14 having further executable instructions for performing the method, comprising:
receiving from a second carrier, a second modification to the first data associated with the first product;
presenting the second modification to the first developer associated with the first product;
receiving an acceptance of the second modification; and
associating the second modification with the first product and the second carrier in addition to associating the first modification with the first product and the first carrier.

16. A method of negotiating metadata associated with an application for execution on a wireless device, comprising:
receiving metadata associated with multiple applications;
presenting the metadata to multiple carriers;
providing an automated negotiation forum for the carriers and developers;
receiving into the negotiation forum, modifications to the metadata from carriers, modifications to the metadata from developers, acceptance requests from carriers and acceptance requests from developers;
associating metadata associated with one of the multiple applications with a carrier.

17. A system for negotiating metadata associated with an application for execution on a wireless device, comprising:
means for receiving metadata associated with multiple applications;
means for presenting the metadata to multiple carriers;
means for providing an automated negotiation forum for the carriers and developers;
means for receiving into the negotiation forum, modifications to the metadata from carriers, modifications to the metadata from developers, acceptance requests from carriers and acceptance requests from developers;
means for associating metadata associated with one of the multiple applications with a carrier.

18. A method for providing a negotiation forum, comprising:
providing electronic access to an automated system to multiple delivery entities and multiple receiver entities;
presenting to the multiple receiver entities metadata associated with products associated with the multiple delivery entities;
receiving modification terms associated with the metadata associated with the products associated with the multiple delivery entities;
receiving acceptance of modifications to the metadata; and
associating the modification of the metadata with multiple receiver entities.

19. A computer-readable medium having computer executable instructions that when execute perform a method for providing a negotiation forum, comprising:
providing electronic access to an automated system to multiple delivery entities and multiple receiver entities;
presenting to the multiple receiver entities metadata associated with products associated with the multiple delivery entities;
receiving modification terms associated with the metadata associated with the products associated with the multiple delivery entities;
receiving acceptance of modifications to the metadata; and
associating the modification of the metadata with multiple receiver entities.
